(19) United States
(12) Patent Application Publication
(10) Pub. No.: US 2024/0162462 A1
(43) Pub. Date: May 16, 2024

(54) METHOD FOR CALIBRATING A FUEL SENSOR

(71) Applicant: Robert Bosch GmbH, Stuttgart (DE)

(72) Inventor: Jochen Braun, Heimsheim (DE)

(21) Appl. No.: 18/552,661

(22) PCT Filed: Mar. 15, 2022
(86) PCT No.: PCT/EP2022/056730

§ 371 Date: Sep. 26, 2023

(30) Foreign Application Priority Data
Apr. 7, 2021 (DE) 10 2021 203 443.8

(51) Int. Cl. H01M 8/0444; H01M 8/04089; H01M 8/0438; H01M 8/04746

(52) U.S. Cl. CPC H01M 8/0447; H01M 8/04089; H01M 8/04395; H01M 8/04761

(57) ABSTRACT

The invention relates to a method for calibrating a fuel sensor (S) of a fuel cell system (100), wherein the method comprises the following steps:
1) opening a bypass valve (BV) in the bypass line (13) in order to operate the bypass line (13) in the open state;
2) closing shut-off valves (SV1, SV2) in the air supply line (11) and in the exhaust air line (12) in order to conduct all supply air from the air supply line (11) past the at least one fuel cell (101) and introduce it into the exhaust air line (12),
3) carrying out a zero-point calibration of the fuel sensor (S).

### BACKGROUND

The invention relates to a method for calibrating a fuel sensor, a corresponding fuel cell system having a correspondingly calibrated fuel sensor, and a vehicle having a corresponding fuel cell system.

Fuel cell systems are generally known, also as energy suppliers in vehicles. In fuel cell systems, oxygen from the ambient air is generally used as an oxidizing agent and fuel or hydrogen is generally used as a reducing agent in order to react to water (or water vapor) in the fuel cell stack of the system and to supply an electrical power by electrochemical conversion. The ambient air is provided to the fuel cell stack mostly by means of a cathode system having an air compression system. The hydrogen is generally stored in a high-pressure tank (e.g., 700 bar) and supplied to the fuel cell stack via lines and valves and recirculated in a loop-like anode system of an anode system. In operation, the anode loop must be rinsed (“purge”) and dewatered (“drain”) in a periodic manner in order to lower the increasing nitrogen content (by diffusion via the membrane) and the sufficient water in the anode. A part of the purge gas is also hydrogen, for which reason the purge gas is directed into the air system exhaust channel and diluted there through the air mass flow to the extent that no explosive mixture can be produced.

The fuel cell stack typically comprises a plurality of fuel cells that are sealed against one another with many seals. However, these seals are subjected to temperature changes, pressure changes, etc., and age accordingly. Therefore, the fuel cell stacks are usually not tight in the absolute sense. On the other hand, the high-pressure tanks for storing the hydrogen or its fittings, actuators, sensors, and/or pipes can leak.

Because hydrogen is very volatile and can form an explosive mixture with air, especially in confined or enclosed spaces, it is relevant for safety to identify any possible hydrogen leaks. A plurality of hydrogen sensors are typically installed for hydrogen leakage detection. These sensors carry significant costs. In addition, the sensors must be calibrated with great effort in order to meet high safety specifications.

### SUMMARY

According to a first aspect, the invention provides a method for calibrating a fuel sensor having the features of the; according to a second aspect, a corresponding fuel cell system with a correspondingly calibrated fuel sensor; and according to a third aspect, a vehicle with a corresponding fuel cell system. Further advantages, features, and details of the invention arise from the subclaims, the description, and the drawings. Of course, features and details described in connection with individual aspects according to the invention also apply in connection with the other aspects according to the invention and respectively vice versa, so that with respect to the disclosure, mutual reference to the individual aspects of the invention is or can always be made.

According to the first aspect, the present invention provides a method for calibrating a fuel sensor of a fuel cell system. The fuel cell system can be configured for a vehicle. The fuel cell system can comprise the following elements:
at least one fuel cell, at least one fuel cell per fuel cell stack, wherein preferably a plurality of fuel cell stacks can be provided, which may be configured with a stack environment ventilation system,
a cathode system for providing an oxygen-containing reactant to the at least one fuel cell,
wherein the cathode system comprises an air supply line for providing an air supply to the at least one fuel cell and an exhaust air line for removing exhaust air from the at least one fuel cell,
and wherein the cathode system comprises a bypass line connecting the air supply line and the exhaust air line in order to guide the supply air from the air supply line at least in part past the at least one fuel cell and introduce it into the exhaust air line,
and an anode system for providing a fuel-containing reactant, e.g., hydrogen, to the at least one fuel cell,
which may be configured with an anode system environment ventilation system,
wherein the anode system comprises a purge and/or drainage system for flushing the anode system and/or for draining product water from the anode system,
and a tank system, preferably of modular construction, having at least one tank or having multiple tanks per module for the fuel-containing reactant, which may be configured with a tank system environment ventilation system.

The fuel sensor as defined in the invention is arranged in the exhaust air line of the fuel cell system. Advantageously, the fuel sensor is configured so as to sense a fuel leakage and/or a fuel mass flow from any possible fuel sources within and outside the fuel cell system. Preferably, in the sense of the invention, the fuel sensor is configured so as to sense a fuel leakage and/or a fuel mass flow from all subsystems of the fuel cell system that can be direct and/or indirect sources of a fuel leakage and/or a fuel mass flow. This includes, for example, the purge and/or drainage system, the stack environment ventilation system, the anode system environment ventilation system, and/or the tank system environment ventilation system, if present. The cathode path itself can be referred to as an indirect source, which can contain fuel by various effects, such as membrane leakage or so-called “proton pump.”

The method in the sense of the invention comprises the following steps:
opening a bypass valve in the bypass line in order to operate the bypass line in the open state;
closing shut-off valves in the air supply line and in the exhaust air line in order to conduct preferably all of the supply air from the air supply line, through the bypass line, past the at least one fuel cell and introduce it into the exhaust air line,
carrying out a calibration, in particular a zero-point calibration, of the fuel sensor.

The fuel sensor in the sense of the invention can preferably serve as the only fuel sensor in the entire fuel cell system as well as in the entire vehicle. When secondary ventilation systems for fuel-conducting components are used in the vehicle, e.g., ventilation systems of an anode system, a vehicle interior, a trunk system, etc., no separate fuel sensors are required for this purpose. Thus, any direct and/or indirect sources of fuel leakage and/or fuel mass flow can be detected with only one fuel sensor. The fuel sensor can be configured e.g., in the form of a hydrogen sensor.

The purge and/or drainage system can comprise at least one purge and/or drain line. The at least one purge and/or drain line can form a combined purge and/or drain line. However, the at least one purge and/or drain line can also comprise two separate drain lines comprising a purge drain line for a purge operation and a drain output line for a drain operation.

The stack environment ventilation system can comprise at least one stack environment ventilation line. The at least one stack environment ventilation line can include one respective stack environment ventilation line per fuel cell or stack, or can be configured as a joint stack environment ventilation line in order to remove from the stack environment the gas or mixture used for venting the near or direct environment of the fuel cell or stack.

The anode system environment ventilation system can comprise at least one anode system environment ventilation line. The at least one anode system environment ventilation line serves to remove from the anode system environment the gas or mixture of gases used for venting the near or direct environment of the components of the anode system.

The tank system environment ventilation system can comprise at least one tank ventilation line. The at least one tank ventilation line can comprise a respective tank ventilation line per tank or per module of multiple tanks, or can be configured as a joint tank ventilation line for removing from the tank system environment the gas or mixture of gases used for venting the near or direct environment of the tank system.

It can further be provided that the at least one purge and/or drain line, the at least one stack environment ventilation line, and/or the at least one tank ventilation line, preferably all ventilation lines, open into the exhaust air line, in particular directly before the fuel sensor, or are fluidly connected there.

The fuel sensor can preferably be arranged downstream in the exhaust air line of the cathode system. The fuel sensor can advantageously be arranged in the exhaust air line by means of a media merging device. The media merging device can be configured with or without a water supply function. The media merging device can ensure that the exhaust air from the at least one fuel cell, if applicable with the other media streams from the fuel cell system, flows through the media merging device and is mixed there, preferably before draining to the surrounding environment.

Downstream in the exhaust air line can be approximately at the end of the exhaust air line, wherein, after the fuel sensor according to the invention, only one muffler can be arranged in the exhaust air line.

The fuel cell system can be used not only for mobile applications, e.g., in motor vehicles, rather also for stationary applications, e.g., in generator systems.

Sources of fuel include at least:
the at least one purge and/or drain line (desired source of fuel mass flow),
if applicable, the at least one stack environment ventilation line (undesired source of fuel leakage),
wherein the at least one stack environment ventilation line can comprise a plurality of stack environment ventilation lines,
regardless of whether the at least one fuel cell or the at least one fuel cell stack is arranged without an additional housing, at least in part or entirely in an additional housing,
optionally the at least one tank environment ventilation line,
wherein the at least one tank environment ventilation line can comprise a plurality of tank ventilation lines,
regardless of whether the tank system is arranged without an additional housing, at least in part or entirely in an additional housing,
optionally the at least one anode system environment ventilation line,
regardless of whether the anode system is arranged without an additional housing, at least in part or entirely in an additional housing,
an indirect source of fuel leakage can also be referred to as the cathode path, which can contain fuel due to fuel transfer through the membrane or other effects,
wherein further ventilation systems and/or sources of possible fuel leakages as well as fuel mass flows can be fluidly connected to the exhaust air line just before the fuel sensor, analogously to the aforementioned ventilation lines.

Advantageously, the detection and dilutions can be carried out for all possible (undesired) fuel leakages and/or all possible (desired) fuel mass flows at one location using only one fuel sensor.

Advantageously, the fuel accumulations can be diluted at least by the exhaust of the cathode system and, if applicable, by the bypass air of the cathode system.

Advantageously, a diagnostic method and/or a monitoring method with pin pointing, i.e., detection from which source the fuel leakage and/or the fuel mass flow originates, can be carried out.

A further advantage is that the exhaust air line can serve to discharge water to the environment or to discharge water to another functional system of the fuel cell system and/or to a container for further use.

Furthermore, it can be advantageous that the dilution of the optionally fuel-containing exhaust air can be carried out by means of a secondary air mass flow, e.g., a fresh air fan of a vehicle interior and/or a separate ventilation fan. In this way, a decoupling from the air compressor operation in the air supply line and/or redundancy to the air compressor operation can be created.

The concept of the invention lies in the fact that such a fuel sensor can be calibrated easily and with little effort. For zero-point calibration, the bypass valve is opened, and the shut-off valves for the stack are closed so as to ensure that all of the air supply is guided past the stack and enters the exhaust air line. The invention proceeds from the concept that, in this case, only fresh or fuel-free air flows past the fuel sensor. The sensor can thus be calibrated to zero.

All further subsystems present in the system, which can be sources of fuel, such as the purge and/or drainage system, as well as any ventilation systems such as the anode system environment ventilation system, the stack environment ventilation system, and tank system environment ventilation system, can be closed in order to carry out a zero-point calibration of the fuel sensor. Thereby, with an increased likelihood, it can be ensured that only fresh air will flow past the fuel sensor.

Furthermore, in a method for calibrating a fuel sensor, it can be provided that the method comprises at least another of the following steps:
2a) operating a compressor in the air supply line in at least one speed,
2b) determining, e.g., calculating or estimating, a target mass flow of the oxygen-containing reactant that is to arrive at the fuel sensor,
2c) checking, e.g., by measuring and calculating, the mass flow of the oxygen-containing reactant that is to be present at the fuel sensor using measured values of a mass flow sensor in the cathode system, e.g. in the air supply line,
2d) checking and/or measuring a pressure in the cathode system by means of a pressure sensor, for example in the exhaust air line of the cathode system,
2e) varying the speed at which the compressor is operated,
3a) monitoring the measurement results of the fuel sensor, and/or
3b) determining that the fuel sensor is functional when the measurement results of the fuel sensor do not change upon varying the speed of the compressor, upon varying the mass flow of the oxygen-containing reactant at the sensor, and/or upon varying the pressure in the cathode system.

The measurement results of the fuel sensor are intended to be independent of the mass flow rate at the sensor or the pressure of the exhaust air. Also, the speed of the compressor is not intended to affect the measurement results of the fuel sensor. When the fuel sensor is functional, its measurement results will not change substantially (a particular noise is not a substantial change) upon varying the speed of the compressor, upon varying the mass flow of the oxygen-containing reactant, and/or upon varying the pressure in the cathode system. In this way, it can be easily and conveniently ensured that the fuel sensor is functional.

Furthermore, the mass flow, for example the mass flow in the exhaust air line, can be measured by a mass flow sensor. In this way, it can be checked whether the anticipated mass flow actually arrives at the mass flow sensor at a particular speed of the compressor.

The pressure, e.g., the pressure in the exhaust air line, can also be measured by a pressure sensor. Thus, it can be checked whether the anticipated pressure is actually prevailing in the exhaust air line at a given speed of the compressor. The measured pressure in the exhaust air line can also be used in order to check and/or perform a plausibility test of the target mass flow.

Furthermore, in a method for calibrating a fuel sensor, it can be provided that the method comprises at least another of the following steps:
(targeted) introduction or injection of an in particular specified mass flow of the fuel-containing reactant into the exhaust air line before the fuel sensor,
carrying out a quantity point calibration of the fuel sensor, in particular for an anticipated concentration of the fuel-containing reactant at the fuel sensor.

In this way, in addition to a zero-point calibration, a quantity point calibration of the fuel sensor can be carried out. In so doing, it can advantageously be ensured that the concentration of the fuel in the exhaust air does not exceed a critical limit, the so-called explosion limit. For the quantity point calibration of the fuel sensor, fuel can be selectively fed into the exhaust air line through the purge and/or drain line when the anode path is guided to a state that is as defined as possible, e.g., by purging with fresh fuel when the concentration of fuel is high and approximately known.

Furthermore, in a method for calibrating a fuel sensor, it can be provided that the method comprises at least another of the following steps:
4a) operating a compressor in the air supply line in at least one speed,
4b) determining, e.g., detecting and calculating or estimating, a target mass flow of the oxygen-containing reactant that is present at the fuel sensor,
4c) checking (detecting and calculating) the mass flow of the oxygen-containing reactant that is to be present at the fuel sensor using measured values of a mass flow sensor in the cathode system,
4d) checking a pressure in the cathode system by means of a pressure sensor,
4e) varying the speed at which the compressor is operated,
4f) varying the mass flow of the fuel-containing reactant introduced into the exhaust air line before the fuel sensor, and/or
5a) calibrating the fuel sensor to a measurement point corresponding to a particular concentration of the fuel-containing reactant, in particular as a function of the mass flow of the fuel-containing reactant introduced into the exhaust air line before the fuel sensor, the speed of the compressor, the mass flow of the oxygen-containing reactant, and/or the pressure in the cathode system.

By varying the speed of the compressor and/or the mass flow of the fuel-containing reactant introduced into the exhaust air line upstream of the fuel sensor, the concentration of fuel in the exhaust air can be adjusted in order to provide different measurement points for flexible calibration of the fuel sensor at different measurement points.

Additionally, in a method for calibrating a fuel sensor, it can be provided that the method comprises at least another of the following steps:
4g) increasing or reducing or switching off the mass flow of the fuel-containing reactant introduced into the exhaust air line before the fuel sensor,
5b) checking whether and/or how quickly the fuel sensor reacts to increasing or reducing or switching off the mass flow.

In this way, one or more reaction tests can be provided in order to check how quickly the fuel sensor reacts to changes in the concentration of the fuel in the exhaust. In this way, the safety in operation of the fuel cell system can be further increased.

Apart from that, in a method for calibrating a fuel sensor, it can be provided that the method comprises at least another of the following steps:
carrying out a purge operation of the anode system,
evaluating a purge gas using measurement results of the fuel sensor,
adapting the purge operation of the anode system until an anticipated concentration of the fuel-containing reactant in a mass flow of the purge gas is sensed by the fuel sensor.

In this way, the purge gas can be investigated in order to preferably determine the proportion of the fuel, for example in comparison to nitrogen. Thus, improved control of the purge process can be created.

In the context of the disclosure, it is contemplated that the steps of the method according to the invention can be carried out simultaneously, at least in part concurrently, and/or sequentially.

Advantageously, the method can be carried out periodically, in particular after a certain time, and/or regularly, in particular after a particular consumption, for example of the oxygen-containing reactant and/or the fuel-containing reactant, and/or based on a load profile. In this way, it can be ensured that the fuel sensor is repeatedly calibrated in order to ensure reliable operation of the fuel sensor over the lifetime of the sensor.

It is contemplated, for example, that the method is carried out in an integrated fashion in an operation of the fuel cell system, in particular at the moments when no electrical power from the fuel cell system is required. In this way, the method can be integrated into the operation of the fuel cell system without undesired interruptions.

In addition, it is contemplated that the fuel cell system is transitioned into a powerless state for carrying out the method. A powerless state of the fuel cell system can be understood to mean the state when the fuel cell system is not supplying electrical power and the shut-off valves in the air supply line and the exhaust air line of the cathode system are closed. Thus, it can be ensured that the method can be carried out at any time when required, for example, when it is discernible that the fuel sensor does not provide reliable results.

According to the second aspect, the invention provides a fuel cell system having a fuel sensor, which is calibrated by a method that can proceed as described above, wherein the fuel sensor is arranged in the exhaust air line and configured so as to sense a fuel leakage and/or a fuel mass flow in all subsystems of the fuel cell system, which can be present in the system and sources of a fuel leakage and/or a fuel mass flow. Using the fuel cell system according to the invention, the same advantages can be achieved as described above in connection with the method according to the invention. In the present case, reference to these advantages is made in full.

According to the third aspect, the invention provides a vehicle having a fuel cell system, which can be configured as described above. Using the vehicle according to the invention, the same advantages can be achieved as described above in connection with the method according to the invention. In the present case, reference to these advantages is made in full.

### BRIEF DESCRIPTION OF THE DRAWINGS

The invention and its further developments, as well as its advantages, will be explained in further detail below with reference to drawings. The drawings schematically show:

FIG. 1 a schematic illustration of a fuel cell system in the sense of the invention.

FIG. 2 a schematic illustration of a diagnostic method for possible fuel leakage and/or fuel mass flows in a fuel cell system, and

FIG. 3 a schematic illustration of method for calibrating a fuel sensor in the sense of the invention.

### DETAILED DESCRIPTION

In the various figures, like parts of the invention are always given the same reference numerals, for which reason they are usually only described once.

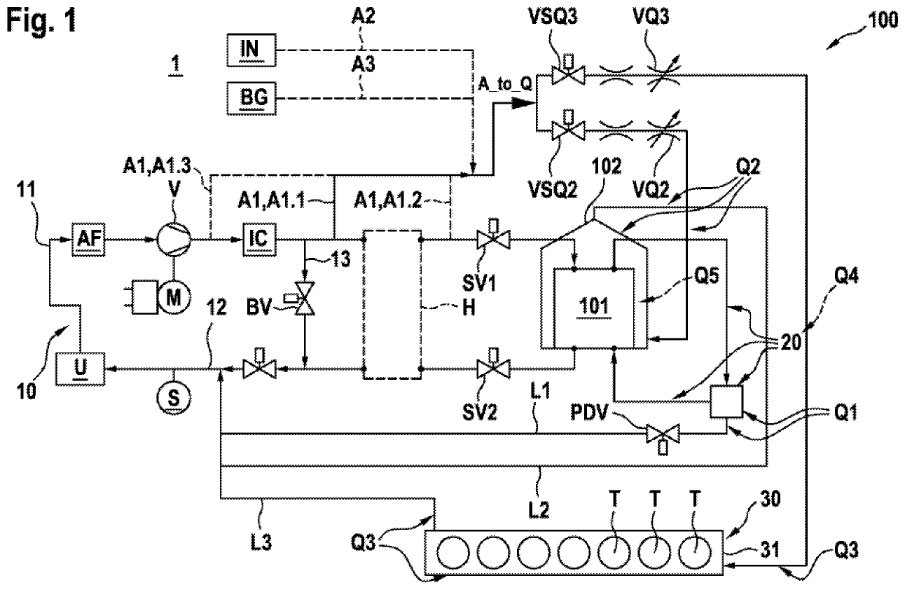

FIG. 1 shows a fuel cell system 100 in the sense of the invention, which can be used, for example, as a source of electrical energy in a vehicle 1, preferably in an electric vehicle and/or a highly automated or even autonomously driving vehicle.

The fuel cell system 100 comprises at least one fuel cell 101, or even a stack of a plurality of fuel cells 101 assembled into a fuel cell stack that is configured with a stack environment ventilation system Q2. The fuel cell 101 or fuel cell stack can have an outward fuel leakage, because the many fuel cells 101 are configured with many seals that are subject to different aging mechanisms through media, mechanical stresses, temperature changes, pressure changes, etc. The fuel cell 101 or fuel cell stack can be received at least in part in a housing 102 (at least in the upper region) so that ventilation of the environment can be targeted. Leaking fuel, in particular hydrogen, can accumulate in an upper region out of which the stack environment ventilation line L2 of the stack environment ventilation system Q2 can lead. The stack environment ventilation line L2 of the stack environment ventilation system Q2 is introduced into an exhaust air line 12 of a cathode system 10 upstream of the fuel sensor S, in particular in the form of a hydrogen sensor. The exhaust air from the exhaust air line 12 of the cathode system 10 can dilute any fuel H2 that may be accumulated.

For the ventilation of the fuel cell 101 or of the fuel cell stack, as the first supplier A1, the air supply from the air supply line 11 of the cathode system 10 or from a further supplier A2, A3, such as a fresh air fan IN in a vehicle interior and/or a separate ventilation fan BG, can be used. The air supply can be introduced to the housing 102 of the fuel cell 101 or the fuel cell stack, preferably in the lower region, via a connection line, for example, which can optionally but advantageously contain a throttle VQ2, VQ3 and/or a controllable valve VSQ2, VSQ3. For the delivery of the mass air flow, various suppliers (such as the air supply line 11, a fresh air fan IN of a vehicle interior and/or a separate ventilation fan BG) for the ventilation lines A1, A2, A3 can be possible, as will be described in detail in the following.

As mentioned above, the fuel cell system 100 comprises a cathode system 10 for supplying an oxygen-containing reactant to the at least one fuel cell 101 or to the fuel cell stack, wherein the cathode system 10 comprises an air supply line 11 for supplying a supply air to the at least one fuel cell 101 and an exhaust air line 12 for removing an exhaust air from the at least one fuel cell 101. The system topology according to the invention provides only one fuel sensor S in the fuel cell system 101 as well as in the entire vehicle 1. Various sources of direct and/or indirect (undesired) fuel leakage and/or (desired) fuel mass flows provided in the system 100 are fed into the exhaust air line 12 of the cathode system 10 by respective existing subsystems Q1, Q2, Q3, Q4, Q5 of the fuel cell system 100.

The cathode system 10 is drawn by way of example in FIG. 1. The supply air can be sucked, for example out of the environment U, and filtered using an air filter AF according to the specifications of the fuel cell 101. Various system topologies are possible with/without a supply air cooler IC, with/without a turbine in the exhaust air line 12, with/without a humidifier H, with a single or multi-stage compression, with a single or multi-flow compressor V, with single or dual shaft systems, with/without water injection, etc.

Furthermore, the fuel cell system 100 comprises an anode system 20 for providing a fuel-containing reactant to the at least one fuel cell 101 or to the fuel cell stack, wherein the anode system 20 comprises a purge and/or drainage system Q1 for purging the anode system 20 and/or for draining product water from the anode system 20. The purge and/or drain line L1 is advantageously introduced into the exhaust air line 12 of the cathode system 10 upstream of the fuel sensor S and diluted there. Also, the anode system 20 can comprise an anode system environment ventilation system Q4 for venting the environment of the components of the anode system 20. The anode system environment ventilation system Q4 can comprise at least one anode system environment ventilation line (not shown) in order to remove from the anode system environment the gas or mixture of gases used for venting the near or direct environment of the components of the anode system 20.

Advantageously, the purge process can not only take place if the cathode system 10 provides sufficient mass air flow/flow rate, but also if this is not the case. For this purpose, by means of the fuel cell system 100, in addition to the air supply from the air supply line 11, further suppliers A2, A3, such as a fresh air fan IN of a vehicle interior and/or a separate ventilation fan BG, can be used.

Furthermore, the cathode system 10 comprises a bypass line 13 fluidly connecting the air supply line 11 and the exhaust air line 12 in order to guide the supply air from the air supply line 11 at least in part past the at least one fuel cell 101 and introduce it into the exhaust air line 12. Preferably, in the air supply line 13, there is provided a bypass valve BV for controlling the amount of supply air directed past the at least one fuel cell 101. The bypass valve BV is opened in order to operate the bypass line 13 in an opened state.

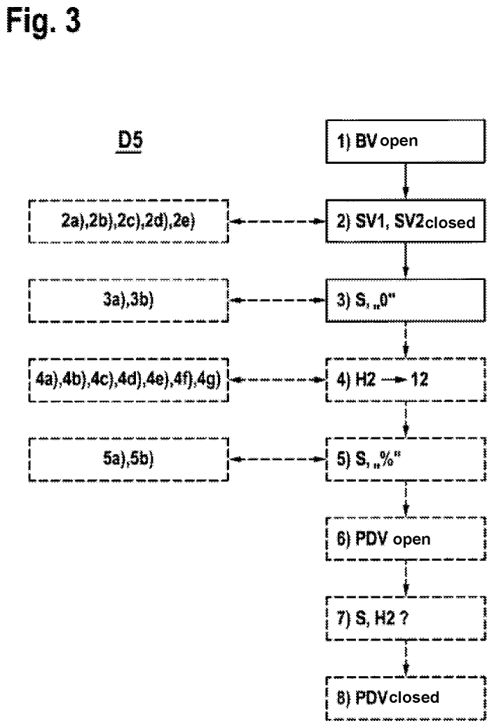

In addition, the cathode system 10 comprises a shut-off valve SV1 in the air supply line 11, just before the air supply line 11 enters the at least one fuel cell 101, and a shut-off valve SV2 in the exhaust air line 12, just after the exhaust air line 12 exits the at least one fuel cell 101. The shut-off valves SV1, SV2 are closed in order to guide the air supply through the bypass line 13 entirely past the at least one fuel cell 101 in order to carry out a calibration of the fuel sensor S (see FIG. 3). Reference to the method according to the invention for calibrating a fuel sensor S is made in detail in connection with FIG. 3 in the following.

Furthermore, the fuel cell system 100 comprises a preferably modularly constructed tank system 30 having at least one tank T (preferably a plurality of tanks T or bottles per module) for the fuel-containing reactant, which is configured with a tank system environment ventilation system Q3. For example, the tank system 30 can be arranged in the rear portion of the vehicle 1 (e.g. in a trunk) but also in an underbody of the vehicle (e.g. below the fuel cell stack or below the passenger compartment). The modular construction of the tank system 20 reduces the distance between the tank system 30 and the stack and/or the cathode path 10, and simpler connections between these systems can be implemented. Advantageously, the individual tanks T can be enclosed in one module, for example, by multiple modules in the tank system 30, by means of a (respective) tank housing 31, which can form part of the tank system environment ventilation system Q3. The tank housing 31 can in turn have a tank ventilation line L3.

For the ventilation of the tank system 30, as the first supplier A1, the air supply from the air supply line 11 of the cathode path 10 and/or the fresh air from a further supplier A2, A3, such as a fresh air fan IN in a vehicle interior and/or a separate ventilation fan BG, can be used.

The supply air for the ventilation is provided by the first supplier A1 via a ventilation line A1, which is branched off from the air supply line 11 of the cathode system 10, e.g. before the humidifier H (ventilation line A1.1), after the humidifier H (ventilation line A1.2), or before the air supply cooler IC (ventilation line A1.3).

The purge and/or drainage system Q1 can comprise a (combined or double) purge and/or drain line L1. The stack environment ventilation system Q2 can comprise at least one (or more) stack environment ventilation line(s) L2. The tank system environment ventilation system Q3 can also comprise at least one (or more) tank ventilation line(s) L3. The anode system environment ventilation system Q4 can also include a ventilation line (not shown). At the end of, or downstream from, the exhaust air line 12 of the cathode system 10, a fuel sensor S, e.g. in the form of a hydrogen sensor, is arranged exclusively in the entire fuel cell system 100 as well as in the entire vehicle 1. According to the present invention, the purge and/or drain line L1, the at least one stack environment ventilation line L2, the at least one tank ventilation line L3, and/or the anode system environment ventilation line, if present, opens into the exhaust air line 12 of the cathode system 10 (preferably all three lines L1, L2, L3) before the fuel sensor S1, as shown in FIG. 1.

In the context of the invention, only one fuel sensor S can be used for the entire fuel cell system 100 as well as for the entire vehicle 1. In the process, in the exhaust air line 12 of the cathode system 10, all lines L1, L2, L3 can be merged, which can be sources of fuel, in particular hydrogen. By way of the example, FIG. 1 shows the purge and/or drain line L1, the stack environment ventilation line L2, regardless of whether the at least one fuel cell 101 or the at least one fuel cell stack is/are open or at least partially arranged within a housing 102, and the tank ventilation line L3, regardless whether the tank system 30 is open or at least partially arranged in a housing 31. However, further sources for possible fuel leakage are also contemplated in the context of the invention, which, like the aforementioned ventilation lines L1, L2, L3, can be fluidly connected to the exhaust air line 12 of the cathode system 10, preferably upstream of the fuel sensor S.

Thus, the detection can be carried out for any possible direct and/or indirect fuel leakage at a location in the fuel cell system 100. Advantageously, the fuel accumulations can be diluted at least by the exhaust of the cathode system 10.

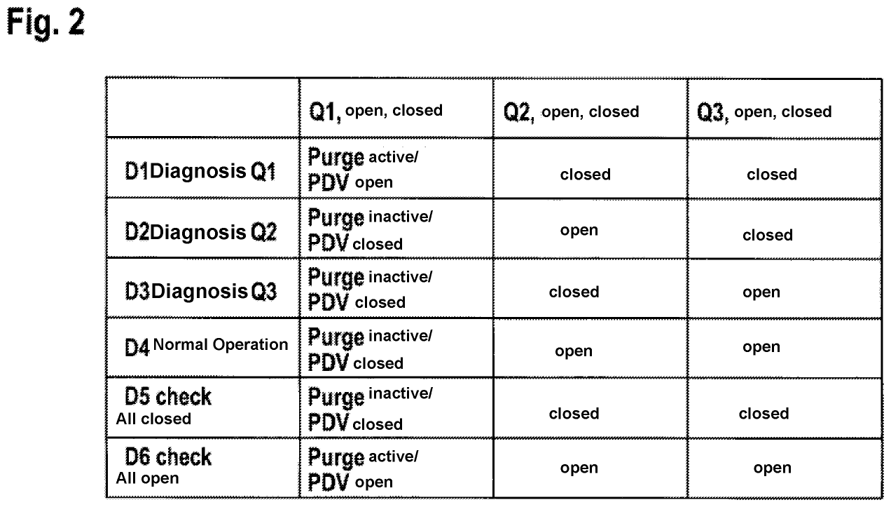

Using the fuel cell system 100 described, a diagnostic method or a verification method with pin pointing, i.e., detection from which source the hydrogen leakage or the hydrogen mass flow originates, can be carried out, as shown in FIG. 2.

By connecting the anode system environment ventilation system Q4, the tank system environment ventilation system Q3, and/or the stack environment ventilation system Q2, if present, to the exhaust air line 12, the fuel H2 accumulated in the respective systems can be reliably guided and diluted.

Advantageously, with the fuel cell system 100 described, it is possible that the dilution of the purge gas by means of a secondary air mass flow A2, A3, e.g., a fresh air fan IN of a vehicle interior and/or a separate ventilation fan BG, can be carried out. Thus, a decoupling of the air compressor operation in the air supply line 11 as well as a redundancy can be created.

However, for the ventilation systems Q2, Q3, Q4 of the tank system 30, the stack, and/or the anode system 20 provided in the system 100, a decoupling from the cathode path 10 as well as redundancy can also be created for the ventilation of the respective systems.

FIG. 2 schematically shows a possible method for diagnosing fuel leakage and/or fuel mass flow in a fuel cell system 100, which can be carried out as described above.

The diagnostic method can comprise at least one of the following steps:
D4) monitoring measured values of the fuel sensor S in ongoing operation (“normal operation”) of the fuel cell system 100.

In the diagnostics in step D4), the measured value or the measured values or the measured signal of the fuel sensor S can be compared to a threshold value or to a plurality of threshold values. The measured value or readings or the measured signal of fuel sensor S can advantageously be evaluated over time in order to be able to detect fuel content increases and leaks early. If the measured value or the measured values or the measured signal of the fuel sensor is sufficiently low, no diagnosis is initially necessary, or depending on the threshold, no more precise diagnosis is necessary. If the values are above an applicable limit, however, further diagnoses D1), D2), D3) can be carried out.

A low limit or a first threshold value, which is not exceeded in step D4), can be a sign of “All OK.” From the low limit upwards, an auditing action can be initiated, for example, such as a more frequent reading of the fuel cell sensor S in step D4), monitoring the fuel content increase, and/or initiating further diagnoses D1), D2, D3). A higher limit or a second threshold value can, for example, lead to a warning action, such as prompting the driver to stop the vehicle 1, prompting the vehicle occupants to leave the vehicle 1, alerting the other road users, etc.

After a certain threshold, the following steps can be initiated:
D1) operating the purge and/or drainage system Q1, wherein the stack ventilation system Q2, the tank ventilation system Q3, and the anode system environment ventilation system Q4, if present, are inactive (i.e., deactivated or not in operation, a purge valve PDV is closed),
D2) operating the stack ventilation system Q2 wherein the purge and/or drainage system Q1, the anode system environment ventilation system Q4, and the tank ventilation system Q3 are inactive, and/or

D3) operating the tank ventilation system Q3, wherein the purge and/or drainage system Q1, the anode system environment ventilation system Q4, and the stack ventilation system Q2 are inactive.

Furthermore, another step, not shown in FIG. 2, can be carried out in which the anode system environment ventilation system Q4 operates, wherein the purge and/or drainage system Q1, the stack ventilation system Q2, and the tank ventilation system Q3 are inactive.

Steps D1), D2, and/or D3) can also be carried out periodically. Thus, tit can be detected from what source the fuel leakage or the fuel mass flow originates.

For this purpose, the respective paths Q1, Q2, Q3, Q4, Q5 of the possible sources present in the system 100 are switched such that only one possible source for a fuel leakage or fuel mass flow is detected.

Between steps D1), D2) and D3), certain wait times and/or averages or recommendations to the user of the vehicle 1 can be set up. Step D4) can be carried out, for example, when parking vehicle 1 or shortly before starting the vehicle 1, in order to quickly check whether the ventilation systems Q2, Q3, Q4 are OK and/or to find out whether an additional diagnosis D2) and/or D3) is required and/or to obtain a reference measurement for steps D2 and/or D3).

In addition, it is contemplated that the measured values in steps D1) to D4) can be compared to one another or in combination with one another in order to perform a plausibility test of the results of the diagnostic procedure (e.g., value in D4=value in 2+value in D3?)

In addition, the diagnostic method can comprise at least one of the following steps:
D5) monitoring of measured values of the fuel sensor S in an unventilated operation (“all closed”) of fuel cell system 100, wherein the purge and/or drainage system Q1, stack ventilation system Q2, tank ventilation system Q3, and anode system environment ventilation system Q4 are all, if present, switched off. Thus, the fuel sensor S1 can be calibrated. Thus, an open/closed diagnosis of a purge valve PVD can also be carried out.

In addition, the diagnostic method can comprise at least one of the following steps:
D6) monitoring of measured values of the fuel sensor S in a fully ventilated operation (“all open”) of fuel cell system 100, wherein the purge and/or drainage system Q1, the stack environment ventilation system Q2, the tank environment ventilation system Q3, and anode system environment ventilation system Q4 are all, if present, switched off. This step D6) can be carried out, for example, when parking vehicle 1 or shortly before starting the vehicle 1, in order to quickly check whether everything is OK and/or to find out whether an additional diagnosis D1), D2), and/or D3) is required and/or to obtain a reference measurement for steps D1), D2), and/or D3).

In addition, it is contemplated that the measured values in steps D1) to D6) can be compared to one another or in combination with one another in order to perform a plausibility test of the results of the diagnostic procedure (e.g., value in D1<=value in D6?)

FIG. 3 serves to illustrate the method according to the invention for calibrating a fuel sensor S (or briefly the calibration method), which is used as the only fuel sensor S for sensing and/or monitoring all fuel leakages and/or fuel mass currents in the fuel cell system 100 according to FIG. 1.

The calibration method according to FIG. 3 can be carried out, for example, in step D5) of the diagnostic method according to FIG. 2.

However, it is also contemplated that the calibration method according to FIG. 3 can be carried out as a separate method and/or independently of the diagnostic method according to FIG. 2.

The calibration method in the sense of the invention comprises the following steps:
opening the bypass valve BV in the bypass line 13 in order to operate the bypass line 13 in the open state;
closing the shut-off valves SV1, SV2 in the air supply line 11 and in the exhaust air line 12 in order to conduct preferably all of the supply air from the air supply line 11, through the bypass line 13, past the at least one fuel cell 101, and introduce it into the exhaust air line 12,
carrying out a calibration, in particular a zero-point calibration, of the fuel sensor S.

In this way, it can be ensured that the fuel sensor S receives the air supply from the air supply line 11.

In step 2), preferably all further subsystems Q1, Q2 Q3, Q4, Q5 which are present in the system 100 and can be sources of fuel H2, such as the purge and/or drainage system Q1, as well as all ventilation systems Q2, Q3, Q4, such as the stack environment ventilation system Q2, the tank system environment ventilation system Q3, and the anode system environment ventilation system Q4, if present, and the cathode path as an indirect source Q5 for fuel are closed and/or shut off and/or disconnected.

In this way, it can be ensured that no fuel H2 arrives at the fuel sensor S in order to carry out the calibration, in particular the zero-point calibration, of the fuel sensor 3) in step 3.

The current measurement point of the fuel sensor S can consequently be set to zero.

After step 2) or in step 2), at least one further (sub)step can be provided:
2a) operating a compressor V in the air supply line 11 in at least one speed,

In this way, a mass flow of air supply can be conveyed through the air supply line 11, the bypass line 13, and the exhaust air line 12.

If desired or required, a target mass flow can be calculated, which is estimated to arrive at the fuel sensor S. To this end, after step 2) or in step 2), at least one further (sub)step can be provided:
2b) determining, e.g., measuring or estimating, a target mass flow of the oxygen-containing reactant that is to arrive at the fuel sensor S,

Thus, it can be checked whether the calculated target mass flow actually arrives at the fuel sensor S. To this end, after step 2) or in step 2), at least one further (sub)step can be provided:
2c) checking e.g., measuring and calculating the mass flow of the oxygen-containing reactant that is to arrive at the fuel sensor S using measured values of a mass flow sensor in the cathode system,

Moreover, the pressure in the exhaust air line 12 can be measured in order to determine or verify the target mass flow with increased accuracy. To this end, after step 2) or in step 2), at least one further (sub)step can be provided:
2d) checking or measuring a pressure in the cathode path 10 by means of a pressure sensor,

The determined target mass flow, the measured mass flow, and the pressure can be used in order to check whether the compressor V is functioning properly and/or whether there are leakages in the lines 11, 12, 13.

In a normal case, no fuel H2 is to be sensed at the fuel sensor S. The zero-point calibration can then be carried out with increased certainty.

Furthermore, it is contemplated that at least one further (sub)step can be provided:
2e) varying the speed at which the compressor V is operated.

In this way, multiple operating points in the operation of the compressor V can be driven.

After step 3) or in step 3), at least one further (sub)step can be provided:
3a) monitoring the measurement results of the fuel sensor S.
3b) determining that the fuel sensor S is functional when the measurement results of the fuel sensor S do not change upon varying the speed of the compressor V, upon varying the mass flow of the oxygen-containing reactant, and/or upon varying the pressure in the cathode path 10.

The measurement results of the fuel sensor S are intended to be independent of the mass flow rate or the pressure of the exhaust air. Also, the speed of the compressor is not intended to affect the measurement results of the fuel sensor S. When the fuel sensor S is functional, its measurement results will not change upon varying the speed of the compressor V, upon varying the mass flow of the oxygen-containing reactant at the sensor, and/or upon varying the pressure in the cathode system 10. In this way, it can be easily and conveniently ensured that the fuel sensor S is functional.

Furthermore, the calibration method can comprise at least another of the following steps:
introducing a mass flow of the fuel-containing reactant into the exhaust air line 12 before the fuel sensor S,
carrying out a quantity-point calibration of the fuel sensor S.

In this way, if desired, a calibration of the fuel sensor S can be carried out at different quantity points. For the quantity point calibration of the fuel sensor, fuel can be selectively fed into the exhaust air line 12 through the purge and/or drain line L1 when the anode path is preferably guided to a state that is as defined as possible, e.g., by purging with fresh fuel when the concentration of fuel is high and approximately known. In so doing, it can advantageously be ensured that the concentration of the fuel in the exhaust air does not exceed a critical limit, the so-called explosion limit.

Also in a quantity point calibration, the method can comprise at least one further step:
4a) operating a compressor V in the air supply line 11 in at least one speed,

In this way, the injected mass flow of the fuel-containing reactant in step 4) can be diluted as desired in order to obtain, for example, a certain concentration of the fuel-containing reactant on the fuel sensor S.

Furthermore, the method can comprise at least another of the steps of:
4b) calculating or estimating a target mass flow of the oxygen-containing reactant that arrives at the fuel sensor S,
4c) checking the mass flow of the oxygen-containing reactant that is to arrive at the fuel sensor S using measured values of a mass flow sensor in the cathode path, e.g. in the air supply line 11, and/or
4d) checking a pressure in the cathode path 10 by means of a pressure sensor,

Furthermore, the method can comprise at least another of the following steps:
4e) varying the speed at which the compressor V is operated,
4f) varying the mass flow of the fuel-containing reactant introduced into the exhaust air line 12 before the fuel sensor S, and/or
5a) calibrating the fuel sensor S to a measurement point corresponding to a particular concentration of the fuel-containing reactant, in particular as a function of the mass flow of the fuel-containing reactant introduced into the exhaust air line 12 before the fuel sensor S, the speed of the compressor V, the mass flow of the oxygen-containing reactant at the fuel sensor S, and/or the pressure in the cathode path 10.

In this way, a calibration of the fuel sensor S can additionally be carried out at different quantity points. Here, too, it can advantageously be ensured that the concentration of the fuel in the exhaust air does not exceed a critical limit, the so-called explosion limit.

Advantageously, additional steps for a reaction test of fuel sensor S can be carried out:
4g) increasing or reducing or switching off the mass flow of the fuel-containing reactant introduced into the exhaust air line 12 before the fuel sensor S,
5b) checking whether and/or how quickly the fuel sensor S reacts to increasing or reducing or switching off the mass flow.

Moreover, using the invention, it can be possible for the calibrated fuel sensor S to serve the following purposes:
carrying out a purge operation of the anode system 20,
evaluating a purge gas using measurement results of the fuel sensor S,
adapting the purge operation of the anode system 20 until an anticipated concentration of the fuel-containing reactant in a mass flow of the purge gas is sensed by the fuel sensor S.

In this way, the purge gas can be investigated, preferably for the proportion of the fuel e.g. in comparison to nitrogen. Thus, improved control of the purge process can be created.

Advantageously, it is possible that the results of the diagnostic method according to FIG. 2 and/or the calibration method according to FIG. 3 can be recorded in a memory of fuel cell system 101 or in an online memory.

Furthermore, it is contemplated that the diagnostic method should be carried out according to FIG. 2 and/or the calibration method according to FIG. 3 periodically, e.g. after a certain time, regularly, e.g. after a tank change, tank filling, after a pressure change, upon each long-term parking of the vehicle 1, e.g. overnight or in an airport parking lot, etc., and/or based on a load profile, e.g. after a certain number of start/stops and/or according to a particular performance carried out (kilometer reading of vehicle 1, kilowatts of electrical power of the fuel cell system 100, certain throughput of the compressor), etc. The diagnostic method according to FIG. 2 and/or the calibration method according to FIG. 3 can be evaluated, for example, in a control unit of the fuel cell system 100 or in an online server.

It can also be advantageous to inform the user of vehicle 1 about the results of the diagnostic method according to FIG. 2 and/or the calibration method according to FIG. 3, for example via a display unit, e.g., in a dashboard of the vehicle 1, in a head-up display, or similar.

In addition, it is contemplated that the fuel cell system 100 is transitioned into a powerless state for carrying out the method. A powerless state of the fuel cell system 100 can be understood to mean the state when the fuel cell system is not supplying electrical power and the shut-off valves in the air supply line and the exhaust air line of the cathode system are closed. Thus, it can be ensured that the method can be carried out at any time when required, for example, when it is discernible that the fuel sensor does not provide reliable results.

According to the second aspect, the invention provides a fuel cell system 100 with a fuel sensor S that has been calibrated by a method that can proceed as described above.

A vehicle 1 with a corresponding fuel cell system 100 also constitutes an aspect of the invention.

The above description of the figures describes the present invention solely in the context of examples. Of course, individual features of the embodiments can be freely combined with one another, insofar as technically sensible, without leaving the scope of the invention.

1. A method for calibrating a fuel sensor (S) of a fuel cell system (100) that includes at least one fuel cell (101),—a cathode path (10) for providing an oxygen-containing reactant to the at least one fuel cell (101),
wherein the cathode system (10) includes an air supply line (11) for providing an air supply to the at least one fuel cell (101) and an exhaust air line (12) for removing exhaust air from the at least one fuel cell (101),
and wherein the cathode system (10) includes a bypass line (13) connecting the air supply line (11) and the exhaust air line (12) in order to guide the supply air from the air supply line (11) at least in part past the at least one fuel cell (101) and introduce it into the exhaust air line (12),
and wherein the fuel cell system also includes an anode system (20) for providing a fuel-containing reactant to the at least one fuel cell (101),
wherein the fuel sensor (S) is arranged in the exhaust air line (12) and is configured so as to sense a fuel leakage and/or a fuel mass flow in all subsystems (Q1, Q2, Q3, Q4, Q5) of the fuel cell system (100) which can be sources of a fuel leakage and/or a fuel mass flow, wherein the method comprises the following steps:
1) opening a bypass valve (BV) in the bypass line (13) in order to operate the bypass line (13) in the open state;
2) closing shut-off valves (SV1, SV2) in the air supply line (11) and in the exhaust air lin)e (12) in order to conduct all supply air from the air supply line (11) past the at least one fuel cell (101) and introduce it into the exhaust air line (12), and
3) carrying out a zero-point calibration of the fuel sensor (S).

2. The method according to claim 1, wherein
in step 2), all subsystems (Q1, Q2 Q3, Q4, Q5) of the fuel cell system (100) which can be sources of fuel leakage and/or fuel mass flow, including at least one purge and/or drainage system (Q1) and a stack environment ventilation system (Q2), a tank system environment ventilation system (Q3), and/or an anode path ventilation system (Q4), are switched off and/or blocked as direct sources and a cathode path is disconnected as an indirect source (Q5).

3. The method according to claim 1,
wherein
the method comprises at least another of the following steps:
2a) operating a compressor (V) in the air supply line (11) in at least one speed,
2b) determining a target mass flow of the oxygen-containing reactant that is to arrive at the fuel sensor (S),
2c) checking the mass flow of the oxygen-containing reactant that is to arrive at the fuel sensor (S) using measured values of a mass flow sensor in the cathode system (10),
2d) checking a pressure in the cathode path (10) by means of a pressure sensor,
2e) varying the speed at which the compressor (V) is operated,
3a) monitoring the measurement results of the fuel sensor (S), and/or
3b) determining that the fuel sensor (S) is functional when the measurement results of the fuel sensor (S) do not substantially change upon varying the speed of the compressor (V), upon varying the mass flow of the oxygen-containing reactant, and/or upon varying the pressure in the cathode path (10).

4. The method according to claim 1,wherein
the method comprises at least another of the following steps:
4) introducing a mass flow of the fuel-containing reactant into the exhaust air line (12) before the fuel sensor (S),
5) carrying out a quantity-point calibration of the fuel sensor (S).

5. The method according to claim 4 wherein
the method comprises at least another of the following steps:
4a) operating a compressor (V) in the air supply line (11) in at least one speed,
4b) determining a target mass flow of the oxygen-containing reactant present at the fuel sensor (S),
4c) checking the mass flow of the oxygen-containing reactant that is to be present at the fuel sensor (S) using measured values of a mass flow sensor in the cathode system (10),
4d) checking a pressure in the cathode path (10) by means of a pressure sensor,
4e) varying the speed at which the compressor (V) is operated,
4f) varying the mass flow of the fuel-containing reactant introduced into the exhaust air line (12) before the fuel sensor (S), and/or
5a) calibrating the fuel sensor (S) to a measurement point corresponding to a concentration of the fuel-containing reactant, as a function of the mass flow of the fuel-containing reactant introduced into the exhaust air line (12) before the fuel sensor (S), the speed of the compressor (V), the mass flow of the oxygen-containing reactant on the sensor (S), and/or the pressure in the cathode path (10).

6. The method according to claim 1, wherein
the method comprises at least another of the following steps:
4g) increasing or reducing or switching off the mass flow of the fuel-containing reactant introduced into the exhaust air line (12) before the fuel sensor (S),
5b) checking whether and/or how quickly the fuel sensor (S) reacts to increasing or reducing or switching off the mass flow.

7. The method according to claim 1, wherein
the method comprises at least another of the following steps:
6) carrying out a purge operation of the anode system (20),
7) evaluating a purge gas using measurement results of the fuel sensor (S), or
8) adapting the purge operation of the anode system (20) until an anticipated concentration of the fuel-containing reactant in a mass flow of the purge gas is sensed by the fuel sensor (S).

8. The method according to claim 1, wherein
the steps of the method according to the invention are carried out simultaneously, at least in part concurrently, and/or sequentially,
and/or that the method is carried out regularly,
and/or that the method is carried out in an integrated fashion in an operation of the fuel cell system (100), at moments when no electrical power from the fuel cell system (100) is required.
and/or that the fuel cell system (100) is transitioned into a powerless state.

9. A fuel cell system (100) with a fuel sensor (S) calibrated by a method according to claim 1, wherein the fuel sensor (S) is arranged in the exhaust air line (12) and is configured so as to sense a fuel leakage and/or a fuel mass flow in all subsystems (Q1, Q2, Q3, Q4, Q5) of the fuel cell system (100) which can be sources of a fuel leakage and/or a fuel mass flow.

10. A vehicle (1) with a fuel cell system (100) according to claim 9.
